(19) United States
(12) Patent Application Publication
(10) Pub. No.: US 2015/0037487 A1
(43) Pub. Date: Feb. 5, 2015

(54) FEATHER BASED COMESTIBLE COMPOSITIONS AND METHODS FOR MAKING SUCH COMPOSITIONS

(71) Applicant: Nestec SA, Vevey (CH)

(72) Inventors: Annie Watelain, (US); Thierry Lavallard, Aubigny (FR); Paulo A Fernandes, Amiens (FR)

(73) Assignee: Nestec SA, Vevey (CH)

(21) Appl. No.: 13/956,866

(22) Filed: Aug. 1, 2013

(51) Int. Cl. A23K 1/10

(52) U.S. Cl. CPC A23K 1/106
USPC 426/644

(57) ABSTRACT

The invention provides methods for making a comestible compositions by producing a mixture comprising from about 20 to about 60% feather, from about 30 to about 65% polyol and from about 0.1 to about 3% feather degradation agent; and heating the mixture to a temperature of from about 120 to about 240° C. under a pressure of from, about 200 to about 1000 psi for a period of from about 2 to about 10 minutes. The invention also provides comestible compositions produced by the methods.

### CROSS REFERENCE TO RELATED APPLICATIONS

This application claims priority to U.S. Provisional Application No. 61/679,988 filed Aug. 6, 2012, the disclosure of which is incorporated herein by this reference,

### BACKGROUND OF THE INVENTION

1. Field of the Invention

This invention relates generally to comestible compositions and methods for making such compositions and particularly to feather based comestible compositions and methods for making such compositions.

2. Description of Related Art

Unprocessed leathers are high in protein but much of the protein is indigestible, e.g., only about 60 to 75% of the protein is digestible. The primary protein in feathers is keratin. Keratin contains a relatively high amount of cystine (˜10%) that results in cross-linking in the protein. The cross-linking is the reason much of the protein in feathers is indigestible.

Methods for increasing leather protein digestibility and for using feather protein in foods are known in the art. Generally, such methods involve using hydrolysis to break the cross-links formed by cystine in the feather protein and incorporating the hydrolyzed feather protein into foods. Hydrolysis of feather protein using reducing agents such as copper sulphate and sodium sulfite, enzymes such as pepsin, bacteria such as Bacillus licheniformis, elevated temperatures and pressures such as steam heat at relatively high pressures, acids such as hydrochloric acid, and bases such as sodium hydroxide are known, U.S. Pat. No. 3,806,501 discloses a protein product and process of preparing the product by reacting poultry feather meal, lime, and sodium sulfide, U.S. Pat. No. 4,269,865 discloses a process for the conversion of feathers into a foodstuff wherein moistened feathers are subjected to an elevated temperature and a pressure of 15 to 40 psig. U.S. Pat. No. 4,908,220 discloses methods for hydrolyzing feathers to produce a product useful as dietary protein in animal feed. The method is based on fermentation with Bacillus licheniformis. U.S. Pat. No. 4,665,158 discloses methods for hydrolyzing feathers using gaseous hydrochloric acid. U.S. Pat. No. 6,827,948 discloses methods for processing poultry feathers that involves contacting leathers with detergent, reducing feather particle size, increasing entanglement, adding anionic polymeric adduct and cationic species, and dewatering.

Generally, feather meal is produced by a high-pressure steam processing method. Heat from the steam hydrolyzes the leathers into a cysteine-rich, high-protein composition that is about 60% digestible. The resulting feather meal is used in various food products as a source of protein. However, such proteins are not often used to make comestible foods because the texture of the resulting foods is unappealing.

While there are known methods for producing feather based proteins and feather based protein food products, there is still a need for new leather based food compositions and methods for making such compositions, particularly comestible compositions that have an appealing appearance and texture.

SUMMARY OF THE INVENTION

It is, therefore, an object of the present invention to provide methods for making feather based comestible compositions.

It is another object of the present invention to provide feather based comestible compositions.

It is a further object of the present invention to provide blended food, compositions containing feather based comestible compositions.

One or more of these and other objects are achieved using feather based comestible compositions made by producing a mixture comprising from about 20 to about 60% feather, from about 30 to about 65% polyol, and from about 0.1 to about 3% feather degradation agent; and then heating the mixture to a temperature of from about 120 to about 240° C. under a pressure of from about 200 to about 1000 psi for a period of from about 2 to about 10 minutes.

Other and further objects, features, and advantages of the invention will be readily apparent to those skilled in the art.

### BRIEF DESCRIPTION OF THE DRAWINGS

FIG. 1 shows a feather based comestible composition in an embodiment of the invention showing the comestible composition is a rope form.

FIG. 2 shows a feather based comestible composition in another embodiment of the invention showing the comestible composition is a coiled form.

FIG. 3 shows a feather based, comestible composition in a further embodiment of the Invention showing the comestible composition is a chunk form.

FIG. 4 shows a feather based comestible composition in an embodiment of the invention showing the comestible composition is a different chunk form.

### DETAILED DESCRIPTION OF THE INVENTION

### Definitions

The term “animal” means a human or other animal that could enjoy or benefit from feather based comestible compositions, including avian, bovine, canine, equine, feline, hicrine, murine, ovine, and porcine animals.

The term “companion animal” means domesticated animals such as cats, dogs, birds, rabbits, guinea pigs, ferrets, hamsters, mice, gerbils, horses, cows, goats, sheep, donkeys, pigs, and the like.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be containers of individual feather based comestible compositions and other comestible ingredients physically associated such that they are considered a unit for manufacture, distribution, sale, or use.

The term “virtual package” means that the components of a kit are associated by directions on one or more physical or virtual kit components instructing the user how to obtain the other components, e.g., a bag or other container containing one component and directions instructing the user to go to a website, contact a recorded message or a fax-back service, view a visual message, or contact a caregiver or instructor to obtain instructions on how to use the kit or safety or technical information about one or more components of a kit.

The term “about” means plus or minus 20%, preferably plus or minus 10%, more preferably plus or minus 5%, most preferably plus or minus 2%.

All percentages expressed herein are by weight of the total weight of the composition unless expressed otherwise.

As used herein, ranges encompass each and every value within the range and are used to avoid having to list each and every value within the range. Any appropriate value within the range can be selected, where appropriate, as the upper value, lower value, or terminus of the range.

The invention is not limited to the particular methodology, protocols, and reagents described herein because they may vary. Further, the terminology used herein is for the purpose of describing particular embodiments only and is not intended to limit the scope of the invention.

As used herein, the singular form of a word includes the plural, and vice versa, unless the context clearly dictates otherwise. Thus, the references “a”, “an”, and “the” are generally inclusive of the plurals of the respective terms. For example, reference to “a composition” or “a method” includes a plurality of such “compositions” or “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

Unless defined otherwise, all technical and scientific terms and any acronyms used herein, have the same meanings as commonly understood by one of ordinary skill in the art in the field of the invention. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, and other references cited or referred to herein are incorporated herein by reference to the extent allowed by law. The discussion of those references is intended merely to summarize the assertions made therein. No admission is made that any such patents, patent applications, publications or references, or any portion thereof, are relevant prior art for the present invention and the right to challenge the accuracy and pertinence of such patents, patent applications, publications, and other references is specifically reserved.

### THE INVENTION

In one aspect, the invention provides methods for making comestible compositions. The methods comprise producing a mixture comprising from about 20 to about 60% feather, from about 30 to about 65% polyol, and from about 0.1 to about 3% feather degradation agent; and subsequently beating the mixture to a temperature of from about 120 to about 240° C. under a pressure of from about 200 to about 1000 psi for a period of from about 2 to about 10 minutes.

Any feather in any form from airy bird can be used in the invention. Feather from chickens, ducks, ostriches, turkeys, hawks, penguins, flamingos, and the like are particularly useful in the invention. Preferably, the feather is from chickens or turkeys, most preferably chickens. The feather is generally whole leathers, mechanically processed whole leathers, partially hydrolyzed feathers, feather meal, and combinations thereof. Preferably, the feather is feather meal.

Mechanically processed whole feathers are generally produced by cutting, grinding, milling, or otherwise mechanically processing the feathers to produce feather pieces. Partially hydrolyzed feathers are generally produced by treating feathers with heat pressure, acids, acids, enzymes, bacteria, and the like to hydrolyze a portion of the feather protein. Feather meal is generally produced by mechanically and/or chemically processing feathers and subsequently reducing the particle size to that of a meal. Methods for making these forms of feather are well known to skilled artisans.

Any comestible polyol that is not toxic to animals when used in amounts needed to produce the comestible compositions can be used in the invention. Preferably, the polyol is polyethylene glycol, glycerol, and combinations thereof. Most preferably, the polyol is glycerol.

Any comestible leather degradation agent, that is not toxic to animals when used in amounts needed to produce the comestible compositions can be used in the invention. Preferably, the feather degradation agent is sodium sulfite, sodium metabisulfite, potassium metabisulfite, sodium hydrogen sulfite, calcium hydrogen sulfite, potassium hydrogen sulfite, and combinations thereof. Most preferably, the feather degradation agent is sodium sulfite.

In preferred embodiments, the mixture is heated to a temperature of front about 140 to about 220° C., more preferably from about 160 to about 200° C.

In preferred embodiments, the mixture is under a pressure of from about 300 to about 900 psi, more preferably from about 400 to about 800 psi.

In preferred embodiments, the mixture is heated for a period of from about 3 to about 8 minutes, more preferably from about 4 to about 6 minutes.

In preferred embodiments, the step of heating the mixture is performed using extrusion.

The mixture used in the methods may further comprise contain additional ingredients that serve as functional ingredients to modify the properties of the comestible composition produced by the methods. For example, additional proteins, tats, carbohydrates, fibers, gums, and the like can be used to change the functional, nutritional, or aesthetic properties of the comestible compositions produced. In various embodiments, the mixture may contain from about 2 to about 20% of one or more non-feather based proteins, e.g., wheat gluten, corn gluten, soy protein, or a combination thereof. In those or other embodiments, the mixture may contain from about 2 to about 20% of one or more fats. In one embodiment, the mixture further comprises comestible gums such as guar gum, locust bean gum, or combinations thereof.

In another aspect, the invention provides comestible compositions produced according to the methods of the invention.

The comestible compositions of the invention may contain additional ingredients that serve as functional ingredients to modify the properties of the comestible composition. For example, additional proteins, fats, carbohydrates, fibers, gums, and the like can be used to change the functional, nutritional, or aesthetic properties of the comestible compositions. In one embodiment, comestible gums such as guar gum, locust bean gum. or combinations thereof are used to make the comestible composition softer and more pliable.

In various embodiments, the comestible compositions further comprise one or more additional ingredients that serve as functional ingredients to modify the properties of the comestible compositions. For example, additional proteins, fats, carbohydrates, fibers, gums, and the like can be used to change the functional, nutritional, or aesthetic properties of the comestible compositions. In various embodiments, the comestible compositions contains from about 2 to about 20% of one or more non-feather based proteins, e.g., wheat gluten, soy protein, or a combination thereof. In those or other embodiments, the comestible compositions contain from about 2 to about 20% of one or more fats. Generally, the comestible compositions have a moisture content of from about 4 to about 16%.

The comestible compositions may contain additional ingredients such as vitamins, minerals, fillers, palatability enhancers, oral care ingredients, probiotics, prebiotics, antioxidants, binding agents, flavors, stabilizers, emulsifiers, sweeteners, colorants, buffers, salts, coatings, and the like known to skilled, artisans. Stabilizers include substances that tend to increase the shelf life of the composition such as preservatives, synergists and sequestrants, packaging gases, stabilizers, emulsifiers, thickeners, gelling agents, and humectants. Examples of emulsifiers and/or thickening agents include gelatin, cellulose ethers, starch, starch esters, starch ethers, and modified starches. Specific amounts for each composition component, food ingredient, and other ingredients will depend, on a variety of factors such as the particular components and ingredients included in the composition. Therefore, the ingredient amounts may vary widely and may deviate from the preferred proportions described herein. The amount of such additives in a composition typically is up to about 5% by weight. Further, the compositions may be or may contain additional ingredients intended to maintain or improve the health of the animal, e.g., supplements, medications, herbs, holistic drugs, and the like.

The comestible compositions are used tor any suitable purpose. Generally, the comestible compositions are produced and used alone as a food for animals; as an ingredient of a complete and balanced food composition for animals, e.g., as a protein source for foods for companion animals such as dogs and cats; as a treat for companion animals such as dogs and cats; or as a component of a blended food composition. In various embodiments, the comestible compositions are formulated to provide complete and balanced nutrition for an animal, preferably a companion animal, according to standards established by the Association of American Feed Control Officials (AAFCO), in other embodiments, the comestible compositions are formulated as a snack, treat, toy, chew, or similar composition. In preferred embodiments, the comestible compositions are formulated for canines and felines, particularly as a complete and balanced food for dogs and cats.

In another aspect, the invention provides blended comestible compositions. The compositions comprise one or more comestible compositions produced according to the methods of the invention and one or more other comestible ingredients. The other comestible ingredients are any ingredient compatible with the comestible compositions produced according to the method of the invention, preferably a blend that meets the nutritional and palatability requirements of the animal intended to consume the compositions, in various embodiments, the blended composition comprises from about 10 to about 90% comestible composition produced according to the method of the invention and from about 90 to about 10% other comestible ingredients. In one embodiment, the blended comestible compositions are formulated to provide “complete and balanced” nutrition for a companion animal according to AAFCO standards. In a preferred embodiment, the blended comestible compositions comprise one or more comestible compositions produced according to the methods of the invention and one or more pet food kibbles. In a preferred embodiment, the comestible compositions of the inventions are formulated and sized to be a treat for a companion animal preferably a dog or a cat.

The methods of the invention produce comestible compositions that have a higher percentage of digestible protein than similar feather based compositions. Generally, the compositions of the invention have a protein digestibility of 80% or more, preferably 90% or more. The combination of the Ingredients and the process conditions hydrolyze most of the cystine cross-links to produce a highly digestible comestible composition.

In another aspect, the invention provides kits. The kits comprise in separate containers in a single package or in separate containers, in a virtual package, as appropriate for the kit component, at least one comestible composition produced according to the methods of the invention and one or more of (1) one or more other comestible ingredients; (2) instructions for how to combine a comestible composition produced according to the method of the invention and one or more other comestible ingredients, particularly to produce a blended composition of the present invention; and (3) one or more devices for mixing kit components or containing the admixture.

When the kit comprises a virtual package, the kit is limited to instructions in a virtual environment, in combination with one or more physical kit components. The kit contains comestible compositions and other components. Typically, the comestible compositions and the other suitable kit components (e.g., other comestible ingredients) are admixed just prior to consumption by an animal. The kits may contain the kit components in any of various combinations and/or mixtures. In one embodiment, the kit contains a container comprising a comestible composition of the invention and a container comprising one or more other comestible ingredients or compositions, e.g., pet food kibbles. The kit may contain additional items such as a device for mixing kit components or a device for containing the admixture, e.g., a spoon and/or a food bowl. In another embodiment, the food compositions are mixed with additional nutritional supplements such as vitamins and minerals that promote good health in an animal.

In another aspect, the invention provides a means for communicating information about or instructions for one or more of (1) administering the comestible compositions of the invention to animals; (2) making a blended comestible composition rising the comestible compositions; and (3) administering the blended comestible compositions to animals. The means comprises one or more of a physical or electronic document, digital storage media, optical storage media, audio presentation, audiovisual display, or visual display containing the information or instructions. Preferably, the means is selected from the group consisting of a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a Fire Wire device, a computer memory, and any combinations thereof. The communication means is useful for instructing on the types and benefits the comestible compositions of the invention.

In another aspect, the invention provides packages useful, for containing one or more comestible compositions of the invention. The packages comprise at least one material suitable for containing the comestible compositions of the invention and a label affixed to the material containing a word or words, picture, design, acronym, slogan, phrase, or other device, or combination thereof, that indicates that the package contains the comestible compositions. Typically, such device comprises the words “highly digestible” or “highly digestible hydrolyzed protein” or an equivalent expression printed on the material Any package configuration and packaging material suitable for containing the comestible compositions are useful in the invention, e.g., a bag, box, sachet, bottle, can, pouch, and the like manufactured from paper, plastic, foil, metal, and the like. In preferred embodiments, the package further comprises one or more comestible compositions of the invention. In various embodiments, the package further comprises at least, one window that permits the package contents to be viewed without opening the package. In some embodiments, the window is a transparent portion of the packaging material. In others, the window is a missing portion of the packaging material.

### EXAMPLES

The invention can be further illustrated by the following examples of preferred embodiments thereof although it will be understood that these examples are included merely for purposes of illustration and are not intended to limit the scope of the invention unless otherwise specifically indicated.

### Example 1

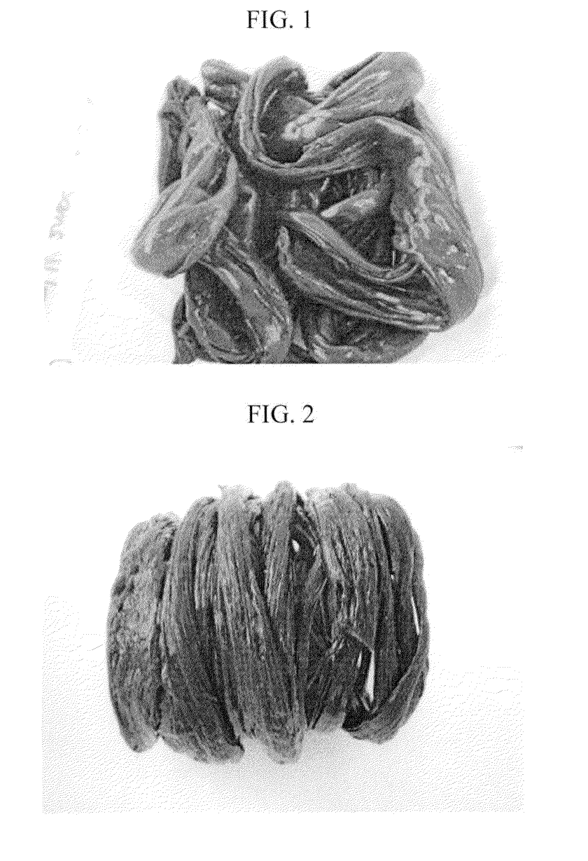

One hundred (100) kilograms (kg) of a textured protein composition, was prepared using the ingredients in the proportions shown in Table 1. The ingredients blended in a Hobart (dough mixer) for 30 minutes at 22° C. The ingredients were extruded at a temperature between 100° C. and 160° C. with a minimum shear mechanical energy (SMH) of about 50 kJ/kg. A twin screw laboratory extruder was used with a long die (5 sections of 0.5 meters per section). The ingredients were fed at 5 to 6 kg/hour into a PRISM 24 mm co-rotating twin screw extruder (L/D—28/1). The screw speed was 900 rpm and the maximum extrusion temperature was 160° C. and pressure of 565 psi. The molten mass was then fed into a long die of a total length 2.5 m and diameter 12 mm. The long die sections were heated respectively from the die to the exit 120-110-100-100-90° C. As the resulting composition exited the cooling die in the form of a rope, the rope was coiled randomly as shown in FIG. 1.

TABLE 1

| Ingredients | % |
|---|---|
| Water | 4.5 |
| Glycerol | 50 |
| Hydrolyzed Feather Meal (HFM) | 45 |
| Sodium Sulfite | 0.5 |

### Example 2

One hundred (100) kg of a textured protein composition was prepared using the ingredients in the proportions shown in Table 2. The dry ingredients HFM, wheat gluten, and sodium sulfite were blended in a Hobart (dough mixer) for 5 minutes at 22° C. The water and glycerol were mixed together in a stainless steel tank. An extrusion was conducted at a temperature between 100° C. and 160° C. with a minimum shear mechanical energy (SME) of about 50 kJ/kg. A twin screw laboratory extruder was used with a long die (5 sections of 0.5 meters per section). The liquid ingredients water and glycerol were mixed. The dry ingredients were fed at 10 kg/hour into a PRISM 24 mm co-rotating twin screw extruder (L/D—28/1) along with the liquid at 11.9 kg/hour. The screw speed was 900 rpm and the .maximum extrusion temperature was 160° C. and pressure of 783 psi. The molten mass was then fed into a long die of a total length 25 m and diameter 12 mm. The long die sections were heated respectively from the die to the exit 120-110-100-100-90° C. As die resulting composition exited the cooling die in the form of a tope, the rope was coiled around a cylinder to create the product shown in FIG. 2.

The experiment was repeated twice to produce (1) a helical composition, formed by coiling the rope around a cylinder, and (2) bite sized pieces, formed by cutting the rope into pieces about 0.5 inches in length.

TABLE 2

| | % |
|---|---|
| Dry Ingredients | |
| Hydrolyzed Feather Meal (HFM) | 40 |
| Sodium Sulfite | 0.5 |
| Wheat Gluten | 5 |
| Liquid Ingredients | |
| Water | 24.5 |
| Glycerol | 30 |

### Example 3

Example 1 was repeated using the ingredients and amounts shown in Table 3. The product had substantially the same appearance as the product shown from Example 1, except that the product was softer and more pliable.

TABLE 3

| Ingredients | % |
|---|---|
| Water | 14 |
| Glycerol | 35 |
| Hydrolyzed Feather Meal (HFM) | 50 |
| Sodium Sulfite | 0.5 |
| Guar Gum | 0.5 |

### Example 4

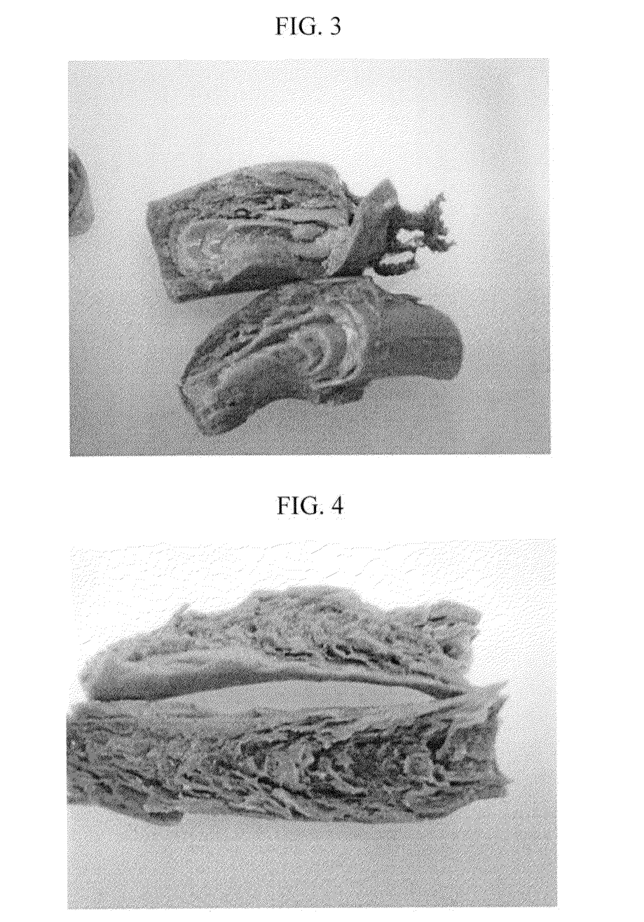

Fifty (50) kg of a textured protein composition was prepared using the ingredients in the amounts shown in Table 4, The dry ingredients HFM, guar gum, corn starch, and sodium sulfite were blended in a Hobart (dough mixer) for 5 minutes at 22° C. The water and glycerol were mixed together in a stainless steel, tank. An extrusion was conducted at a temperature between 100° C. and 160° C. with a minimum shear mechanical energy (SME) of about 50 kJ/kg. A twin screw laboratory extruder was used with a long die (5 sections of 0.5 meters per section). The liquid ingredients water and glycerol were mixed. The dry ingredients were fed at 5 kg/hour into a PRISM 24 mm co-rotating twin screw extruder (L/D—28/1) along with the liquid at 6.68 kg/hour. The screw speed was 900 rpm and the maximum extrusion temperature was 160° C. and pressure of 783 psi. The molten mass was then led into a long die of a total length 2.5 m and diameter 12 mm. The long die sections were heated respectively from the die to the exit 120-110-100-100-90° C. As the rope exited the die it was cut into chunks of about I centimeter length as shown in FIG. 3. The chunks were mixed with a gravy in a ratio about 50/50. The gravy was prepared by blending 0.7% guar gum and 0.07% xanthan. in water with a high speed mixer. The chunks in gravy mixture was then filled in 85 g cans, hermetically sealed. and retorted at 125° C. for 25 minutes.

TABLE 4

| Liquid Ingredients | % | |
|---|---|---|
| Water | 30 | |
| Glycerol | 27.2 | |
| Total | | 57.2% |
| Dry Ingredients | | |
| Guar Gum | 0.3 | |
| 2% Corn Starch Modified | 2 | |
| Hydrolyzed Feather Meal (HFM) | 40 | |
| Sodium Sulfite | 0.5 | |
| Total | | 42.8% |

### Example 5

Forty (40) kg of a meat blend was prepared using the ingredients in the amounts shown in Table 6. The pork lung, frozen liver, and fish frames were ground with a meat grinder through 10 mm openings. The ground meat was then mixed with corn gluten meal in a Hobart dough mixer for 5 minutes. The dough was then, emulsified in a grinder with 3 mm openings.

TABLE 6

| Ingredients | Kg |
|---|---|
| Pork Lung | 7.2 |
| Frozen Liver | 17.2 |
| Fish Frames | 12.8 |
| Corn Gluten Meal | 2.8 |

In parallel, 40.5 kg of a dry blend, was prepared using the ingredients in the amounts shown in Table 7 and blending in a Hobart mixer for 5 minutes.

TABLE 7

| Ingredients | Kg |
|---|---|
| Hydrolyzed Feather Meal (HFM) | 40 |
| Sodium Sulfite | 0.5 |

The meat blend, the dry blend, and liquid glycerol were metered into the extruder as described in Example 2 at a rate of: meat blend at 7.9 Kg/hour; dry blend at 8 Kg/hour, and liquid glycerol at 3.85 Kg/hour. The extrusion temperature was 160° C, at a pressure of 493 psi. The plastic mass was extruded through a long die as in Example 2. The rope was cut in lo chunks as shown in FIG. 4, blended with gravy, and canned using the procedure given in Example 4.

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims the invention may be practiced otherwise than as specifically described.

What is claimed is:

1. A method for making a comestible composition comprising:
producing a mixture comprising from about 20 to about 60% feather, from about 30 to about 65% polyol, and from about 0.1 to about 3% feather degradation agent; and heating the mixture to a temperature of from about 120 to about 240° C. under a pressure of from about 200 to about 1000 psi for a period of from about 2 to about 10 minutes.

2. The method of claim 1 wherein the feather is whole feathers, mechanically processed whole feathers, partially hydrolyzed leathers, feather meal, and combinations thereof.

3. The method of claim 1 wherein the feather is feather meal.

4. The method of claim 1 wherein the polyol is polyethylene glycol, glycerol, and combinations thereof.

5. The method of claim 1 wherein the polyol is glycerol.

6. The method of claim 1 wherein the feather degradation agent is sodium sulfite, sodium metabisulfite, potassium metabisulfite, sodium hydrogen sulfite, calcium, hydrogen sulfite, potassium hydrogen sulfite, and combinations thereof.

7. The method of claim 1 wherein the feather degradation agent is sodium sulfite.

8. The method of claim 1 wherein the mixture is heated to a temperature of from about 140 to about 220° C.

9. The method of claim 1 wherein the mixture is under a pressure of front about 300 to about 900 psi.

10. The method of claim 1 wherein the mixture is heated for a period of from about 3 to about 8 minutes.

11. The method of claim 1 wherein the mixture farther comprises one or more functional ingredients.

12. The method of claim 11 wherein the functional ingredients are proteins, fats, carbohydrates, fibers, gums, and combinations thereof.

13. The method of claim 1 wherein the mixture further comprises from about 0.01 to about 5% of one or more gums.

14. The method of claim 13 wherein the gums are guar gum, locust bean gum, and combinations thereof.

15. A comestible composition produced according to the method of claim 1.

16. The comestible composition of claim 15 further comprising one or more functional ingredients.

17. The comestible composition of claim 16 wherein the functional ingredients are proteins, fats, carbohydrates, fibers, gums, and combinations thereof.

18. The comestible composition of claim 16 wherein the functional ingredients are one or more gums.

19. The comestible composition of claim 18 wherein the gums are guar gum, locust bean gum, and combinations thereof.

20. The comestible composition of claim 15 formulated as a companion animal food.
